(19) United States
(12) Patent Application Publication
(10) Pub. No.: US 2005/0021504 A1
(43) Pub. Date: Jan. 27, 2005

(54) Methods, systems, and computer program products for querying a database for employee data and organizing the obtained data

(76) Inventor: Charles Atchison, Duluth, GA (US)

Correspondence Address: MYERS BIGEL SIBLEY & SAJOVEC, PO BOX 37428, RALEIGH, NC, 27627, US

(21) Appl. No.: 10/624,320

(22) Filed: Jul. 22, 2003

(51) Int. Cl. G06F 17/30

(52) U.S. Cl. 707/3

(57) ABSTRACT

A plurality of query criteria for querying an employee database is defined. The employee database is queried by applying respective ones of the query criteria to respective ones of a plurality of employees. A plurality of folders is provided that respectively correspond to respective ones of the plurality of query criteria. A plurality of workbooks is created that contain the results from querying the employee database for respective ones of the plurality of folders. Respective ones of the plurality of workbooks are associated with respective ones of the plurality of employees that have results for respective ones of the plurality of query criteria.

### BACKGROUND OF THE INVENTION

The present invention relates generally to software databases, and, more particularly, to software databases containing employee data.

Companies frequently store employee information in an electronic database that may be managed using conventional software applications. The database may be a single, centralized database or may be a distributed database spread over multiple data processing systems. In some organizations, several people may be responsible for using and/or maintaining an employee database. As a result, various people may query the database based on performance measure, employee, and/or some other criterion. Unfortunately, multiple people may run the same query or queries, which may consume valuable processor time and/or data storage space, particularly for large databases.

### SUMMARY OF THE INVENTION

According to some embodiments of the present invention, a plurality of query criteria for querying an employee database is defined. The employee database is queried by applying respective ones of the query criteria to respective ones of a plurality of employees. A plurality of folders is provided that respectively correspond to respective ones of the plurality of query criteria. A plurality of workbooks is created that contain the results from querying the employee database for respective ones of the plurality of folders. Respective ones of the plurality of workbooks are associated with respective ones of the plurality of employees that have results for respective ones of the plurality of query criteria.

In other embodiments of the present invention, a first time period is associated with the query criteria. Respective first worksheets are created in respective ones of the plurality of workbooks that contain the results from querying the employee database for respective ones of the query criteria for the first time period.

In still other embodiments, a second time period is associated with the query criteria. Respective second worksheets are created in respective ones of the plurality of workbooks that contain the results from querying the employee database for respective ones of the query criteria for the second time period.

In further embodiments of the present invention, the employee database is queried and the plurality of workbooks is created automatically at a scheduled time.

In still further embodiments of the present invention, user input is received selecting one of the plurality of query criteria. The employee database is queried by applying the selected query criterion to respective ones of the plurality of employees. The results from querying the employee database by applying the selected query criterion are stored in respective ones of the plurality of workbooks for respective ones of the plurality of employees.

In still further embodiments of the present invention, a log file is created that contains a plurality of status indicators for respective ones of the plurality of query criteria. The plurality of status indicators may comprise a query start time, a query stop time, and a number of employees for which the query is applicable.

In still further embodiments of the present invention, the plurality of query criteria comprises a plurality of employee performance criteria.

Although described primarily above with respect to method aspects of querying an employee database, it will be understood that the present invention may also be embodied as systems and computer program products for querying an employee database.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates an exemplary network architecture for accessing an employee database in accordance with some embodiments of the present invention;

FIG. 2 is a block diagram that illustrates a data processing system that can be used to query an employee database in accordance with some embodiments of the present invention;

FIG. 3 is a block diagram that illustrates a software architecture for use in a data processing system for querying an employee database in accordance with some embodiments of the present invention;

FIG. 4 is a flowchart that illustrates operations for querying an employee database in accordance with some embodiments of the present invention;

FIG. 5 is a user interface screen for an employee database query engine in accordance with some embodiments of the present invention;

FIG. 6 is a user interface screen for selecting a time period over which to query an employee database in accordance with some embodiments of the present invention;

FIG. 7 is a user interface screen that provides a status of queries being run on an employee database in accordance with some embodiments of the present invention;

FIG. 8 is a user interface screen that illustrates an arrangement of folders corresponding to query criteria used to query an employee database in accordance with some embodiments of the present invention;

FIG. 9 is a user interface screen that illustrates employee workbooks created in a folder corresponding to a particular query criterion for an employee database in accordance with some embodiments of the present invention;

FIG. 10 is a worksheet containing employee data for a particular query criterion for a particular time period in accordance with some embodiments of the present invention;

FIG. 11 is a log file that contains status indicators for queries that are run on an employee database in accordance with some embodiments of the present invention; and

FIG. 12 is a record associated with a particular employee for which performance criteria are maintained in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

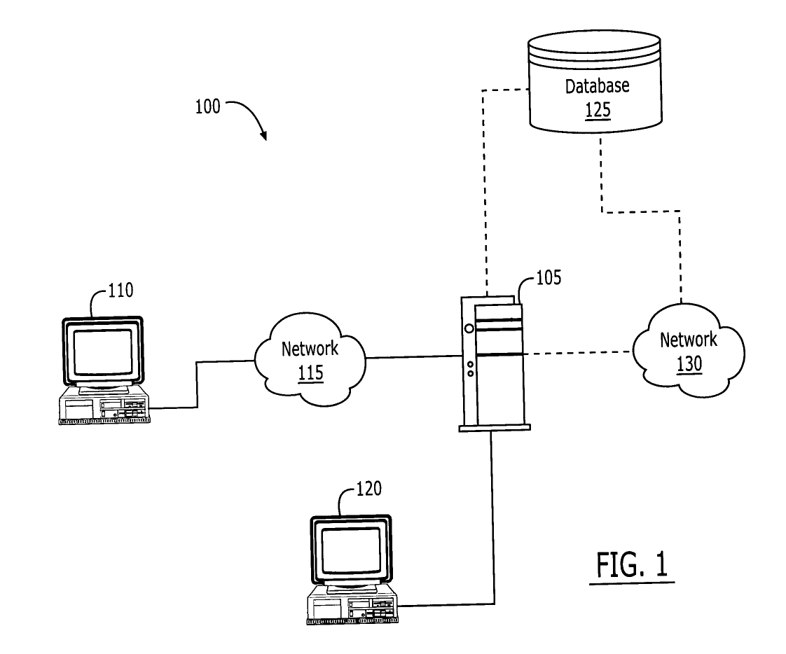

Referring now to FIG. 1, an exemplary network architecture 100 for accessing an employee database, in accordance with some embodiments of the present invention, comprises a data processing system 105 that is coupled to one or more computers 110 over a network 115. The data processing system 105 may also be directly coupled to one or more computers 120. The computers 110 and 120 represent users of an employee database, such as, for example, employees of a personnel department and/or managerial staff in a company. The network 115 may represent a global network, such as the Internet, or other publicly accessible network. The network 115 may also, however, represent a wide area network, a local area network, an Intranet, or other private network, which is not accessible by the general public. Furthermore, the network 115 may represent a combination of public and private networks or a virtual private network (VPN).

The data processing system 115 may be configured with computational, storage, and control program resources for querying an employee database in accordance with some embodiments of the present invention. Thus, the data processing system 115 may be implemented as a single processor system, a multi-processor system, or even a network of stand-alone computer systems. The data processing system 115 may communicate with a local file system for storing the results of employee database queries.

In addition, the data processing system 115 communicate with an employee database 125 either directly and/or over a network 130. The employee database 125 may be implemented as a structured query language (SQL) database in accordance with some embodiments of the present invention. It may be desirable to store employee data in a commercially available database, such as a SQL database, to allow other applications to access the employee data. Advantageously, applications may access the employee database 125 without having to know the proprietary interface of the underlying database. Thus, computers 110 and 120 may access the employee database 125 via the data processing system 105 using standardized SQL requests.

In accordance with various embodiments of the present invention, the data processing system 115, the employee database 125, and the computers 110 and 120 may be remotely located from one another or they may be located in relative close proximity to each other. Therefore, similar to the network 115, the network 130 may represent a global network, such as the Internet, or other network accessible by the general public. The network 130 may also represent a wide area network, a local area network, an Intranet, or other private network, which is not accessible by the general public. Furthermore, the network 130 may represent a combination of public and private networks or a virtual private network (VPN). In view of the foregoing, even though the networks 115 and 130 are illustrated in FIG. 1 as separate networks, any subcombination or combination of networks 115 and 130 may be embodied as a single network.

Although FIG. 1 illustrates an exemplary network architecture 100 for accessing an employee database, it will be understood that the present invention is not limited to such a configuration but is intended to encompass any configuration capable of carrying out the operations described herein.

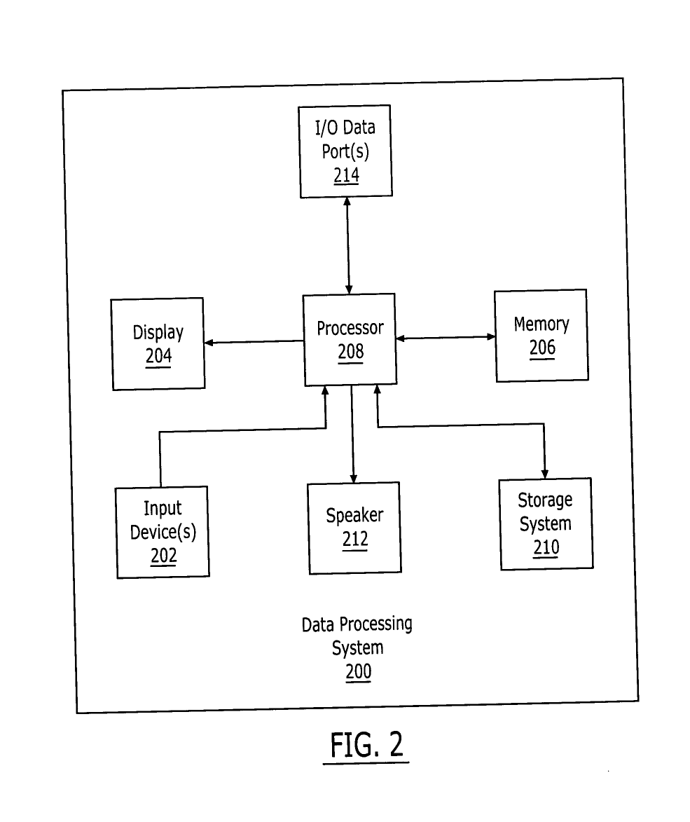

Referring now to FIG. 2, a data processing system 200 that may be used to implement the data processing system 105 of FIG. 1 comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components such as those used in many conventional computing devices, which may be configured to operate as described herein.

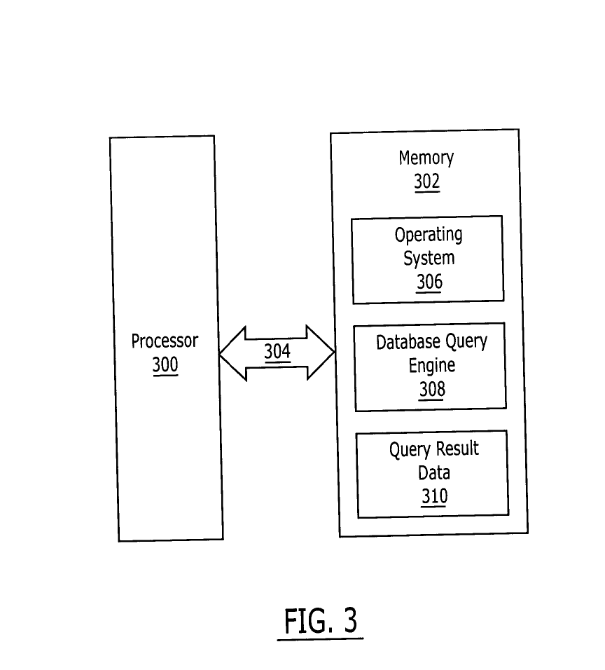

FIG. 3 illustrates a processor 300 and a memory 302 that may be used in embodiments of methods, systems, and computer program products for querying an employee database in accordance with some embodiments of the present invention. For example, in some embodiments of the present invention, the processor 300 and memory 302 may be used to embody the processor 208 and the memory 206, respectively, of FIG. 2. The processor 300 communicates with the memory 302 via an address/data bus 304. The processor 300 may be, for example, a commercially available or custom microprocessor. The memory 302 is representative of the overall hierarchy of memory devices containing the software and data used to query an employee database in accordance with some embodiments of the present invention. The memory 302 may include, but is not limited to, the following types of devices: cache, ROM, PROM, EPROM, EEPROM, flash, SRAM, and DRAM.

As shown in FIG. 3, the memory 302 may hold three or more major categories of software and data: an operating system 306, a database query engine 308, and query result data 310. The operating system 306 controls the operation of the data processing system. In particular, the operating system 306 may manage the data processing system's resources and may coordinate execution of programs by the processor 300.

The database query engine 308 may be configured to query an employee database, such as the employee database 125 of FIG. 1, and to organize the query results in a manner that facilitates access to the results by a user. The query result data 310 is the data obtained from the employee database as a result of running queries on the employee database.

Although FIG. 3 illustrates an exemplary software architecture that may facilitate querying an employee database, it will be understood that the present invention is not limited to such a configuration but is intended to encompass any configuration capable of carrying out the operations described herein.

Computer program code for carrying out operations of data processing systems discussed above with respect to FIGS. 2 and 3 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for querying an employee database, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

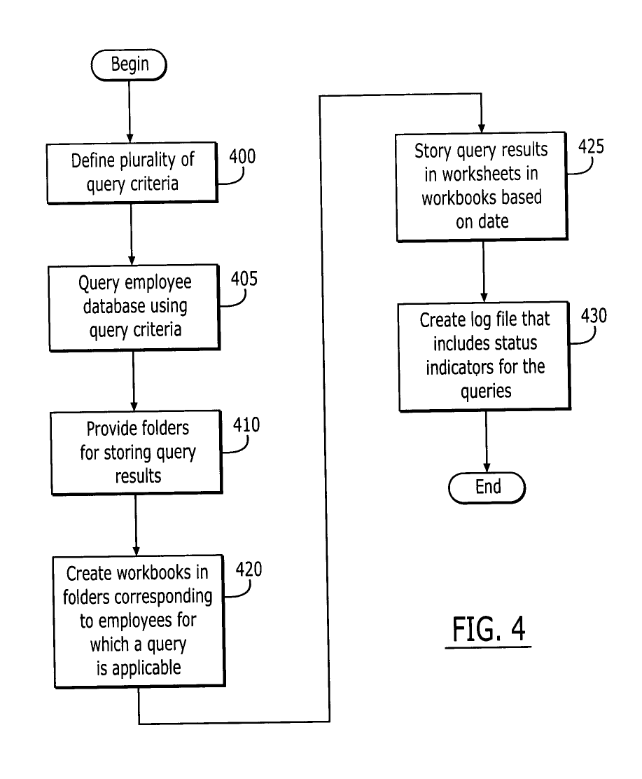

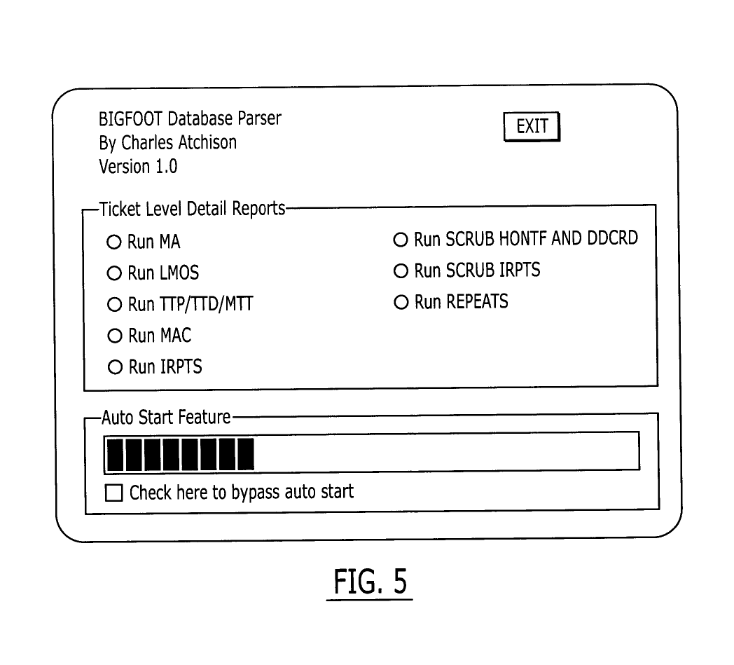

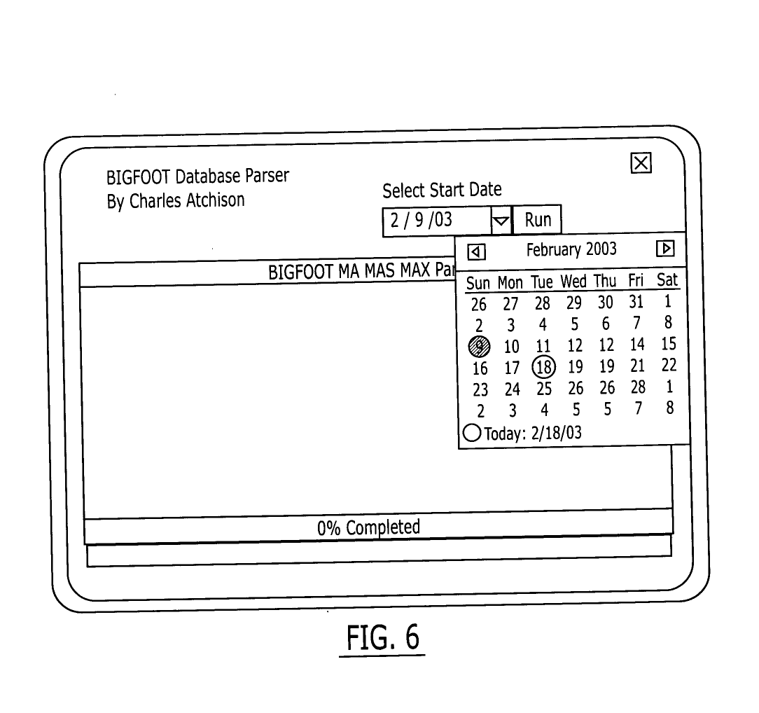

Referring now to FIG. 4, exemplary operations for querying an employee database, in accordance with some embodiments of the present invention, will now be described. Operations begin at block 400 where a plurality of employee database query criteria is defined. These query criteria may be employee performance criteria that are used to objectively measure and/or evaluate an employee's job performance. An employee database, such as the employee database 125 of FIG. 1, is queried at block 405 using the query criteria defined at block 400. As shown in FIG. 5, the database query engine 308 of FIG. 4, for example, may be invoked to query the employee database 125. The database query engine 308 may be run at a scheduled time and/or on a periodic basis in accordance with some embodiments of the present invention. In other embodiments, the database query engine may be run in a manual mode in which a user interactively selects one or more of the query criteria to be used for querying the employee database 125. As shown in FIG. 5, a user interface screen allows a user to bypass the automatic start so as to run in a manual mode in which one or more query criteria may be selected from the “Ticket Level Detail Reports” portion of the interface. When running in manual mode, the user may select a date over which the query or queries are to be run as shown in FIG. 6.

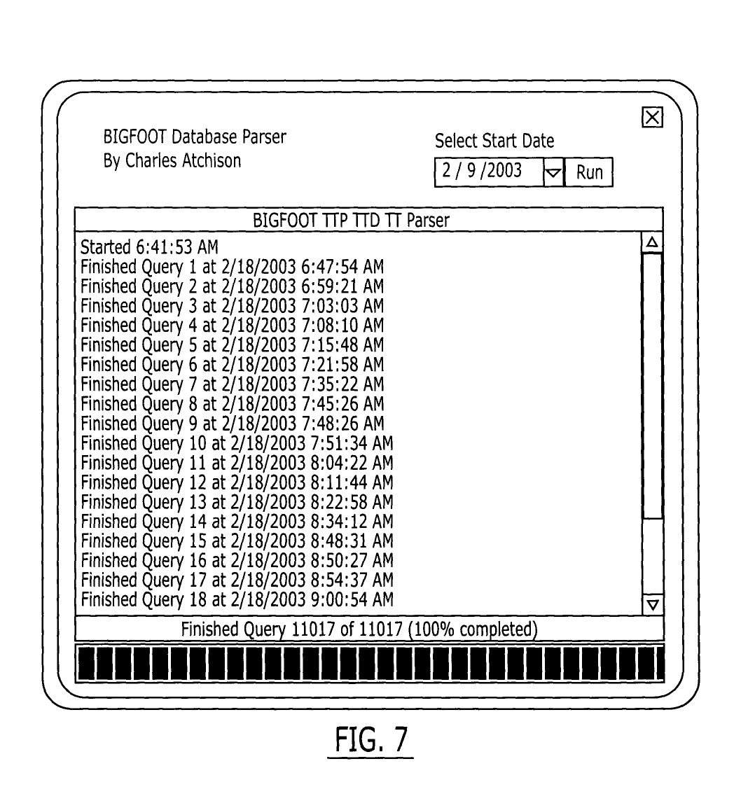

Referring now to FIG. 7, the status of running the various queries on the employee database 125 is presented by providing a progress bar, an indication of what percentage of the total number of queries to be run have completed, a start time at which the database query engine 308 began querying the employee database 125, time stamps for the completion of each query that is run, and a total number of queries to be run and the total number ran.

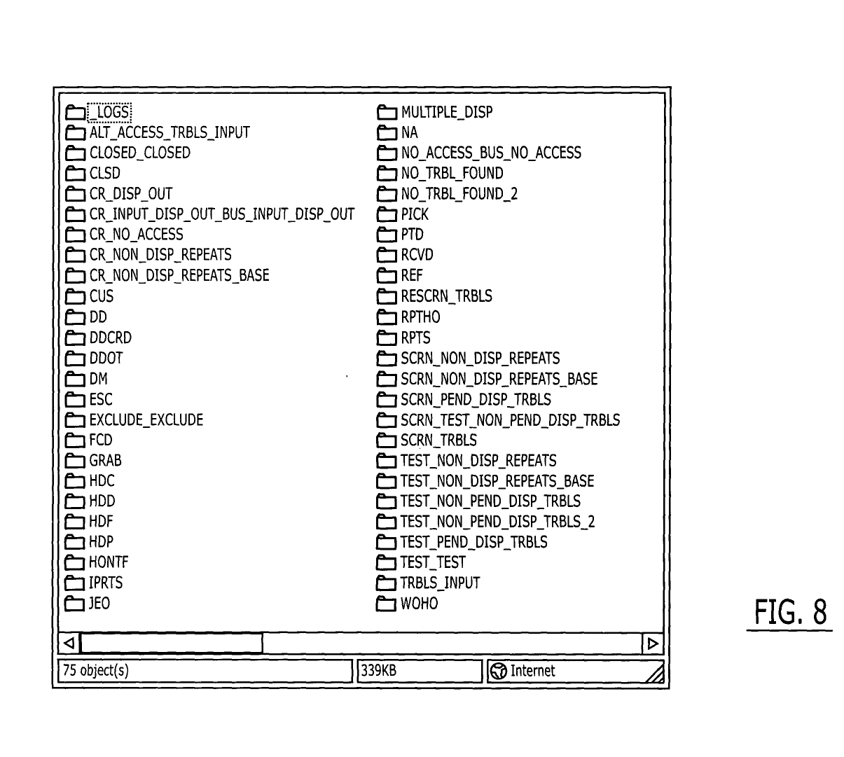

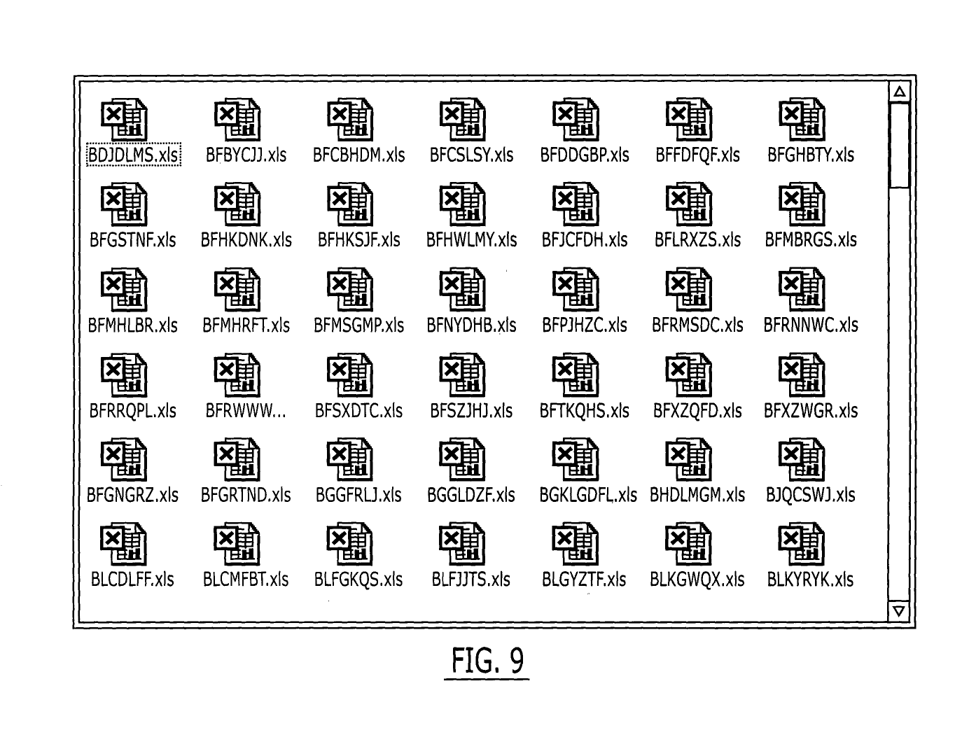

Returning to FIG. 4, folders are provided for storing the query result data at block 410. As shown in FIG. 8, these folders respectively correspond to the queries run by the database query engine 308. At block 420, workbooks are created in the folders corresponding to employees for which a query is applicable. This is illustrated in FIG. 9 where multiple workbooks, e.g., Excel spreadsheets, are created—one workbook for each employee that has data for a particular query criterion. Thus, the workbooks shown in FIG. 9 are all stored in one folder corresponding to a particular query criterion.

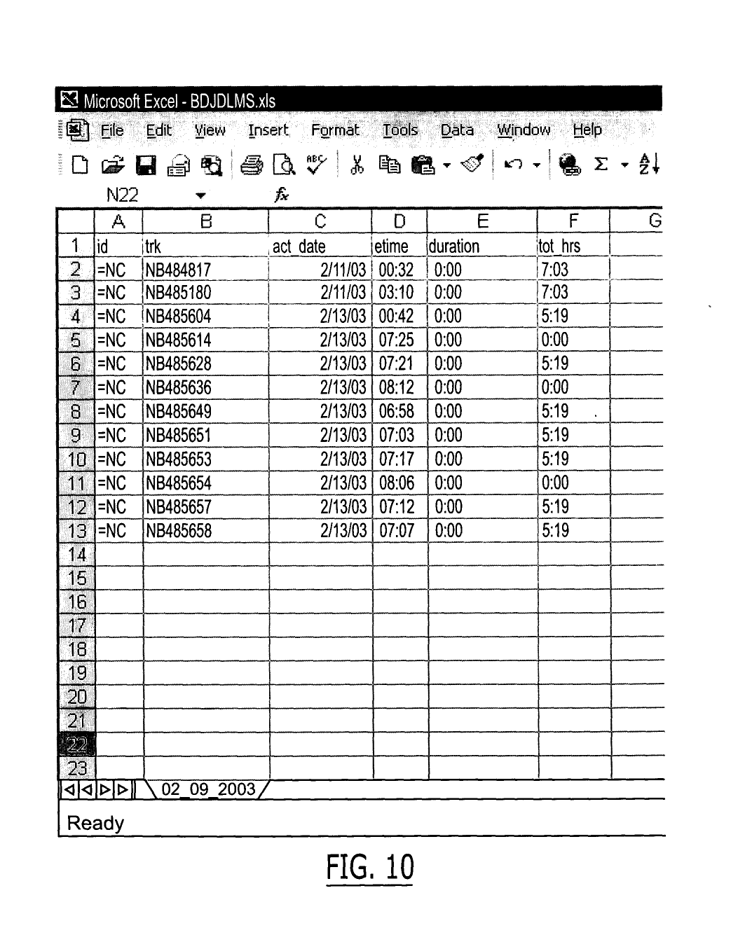

At block 425 of FIG. 4, the results from querying the employee database 125 are stored in the workbooks in the form of worksheets. In particular embodiments of the present invention illustrated in FIG. 10, a worksheet is associated with a time period. A worksheet will only be created in a workbook if the employee has query results for that particular query criterion during that particular time period. Additional worksheets may be added to the workbooks as additional queries of the employee database 125 are run for additional time periods.

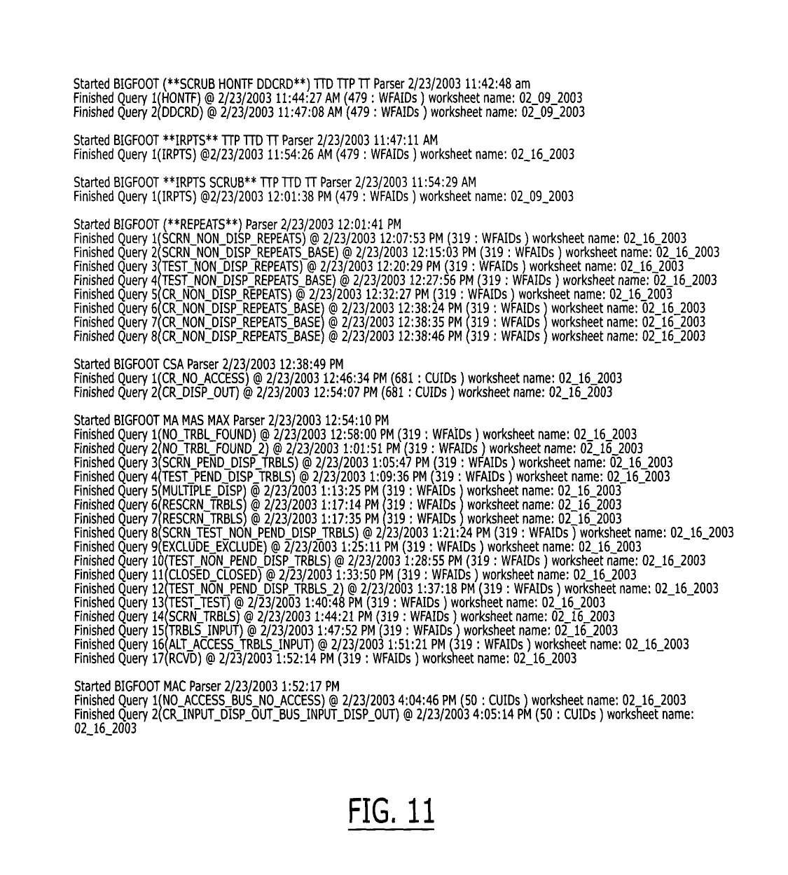

A log file may be created at block 430 that contains status indicators for the queries that run on the employee database 125. An example log file is illustrated in FIG. 11 and includes start and stop times for the various queries that are run along with a number of employees (shown as WFAIDs and CUIDs in FIG. 11) for which a particular query is applicable. Advantageously, a user may detect if one or more queries fail to complete by examining the log file and choose to manually rerun those queries again in manual mode. As shown in FIG. 8, a folder may be created for storing the log file.

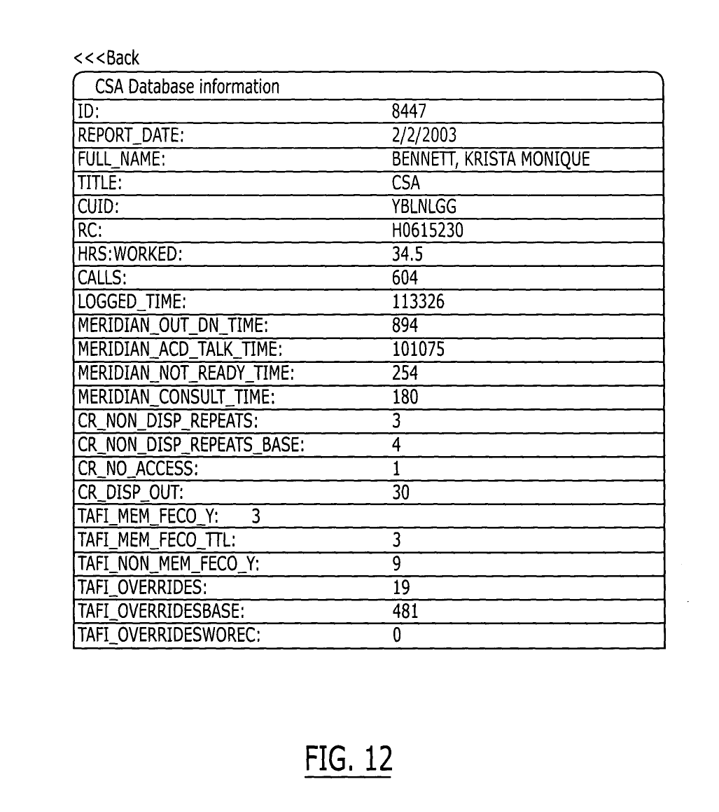

Referring now to FIG. 12, the workbooks for the various employees may be linked via hyperlink from a Web site allowing a user to click on an employee workbook and obtain data stored for that particular employee. As shown in FIG. 12, an employee record may include the employee's name and title along with various performance criteria for which queries may be developed such as hours worked, service calls made, etc.

The flowchart of FIG. 4 illustrates the architecture, functionality, and operations of querying an employee database in accordance with some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

Advantageously, embodiments of the present invention may obviate a need for multiple users to query an employee database for employee performance data, for example. Instead, the database query engine 308 may be scheduled to run periodically to collect performance data for a group of employees. The performance data is organized by performance criterion with each employee having data for that criterion having a workbook associated therewith containing that employee's data. Thus, users may review the obtained data by going to the appropriate performance criterion folder and examining the data for employees for which that performance criterion is applicable. This may reduce instances of users running redundant queries on the employee database and consuming processor time and memory unnecessarily. Furthermore, embodiments of querying an employee database according to the present invention may be scaled to allow for additional queries and employees without changing the general architecture described above. Data backup and storage may also be simplified as the various folders containing employee data for various performance measures may be stored together or separately in accordance with various embodiments of the present invention.

Many variations and modifications can be made to the preferred embodiments without substantially departing from the principles of the present invention. All such variations and modifications are intended to be included herein within the scope of the present invention, as set forth in the following claims.

1. A method of querying an employee database, comprising:
defining a plurality of query criteria;
querying the employee database by applying respective ones of the query criteria to respective ones of a plurality of employees;
providing a plurality of folders, respective ones of the plurality of folders corresponding to respective ones of the plurality of query criteria; and
creating a plurality of workbooks containing results from querying the employee database for respective ones the plurality of folders, respective ones of the plurality of workbooks being associated with respective ones of the plurality of employees that have results for respective ones of the plurality of query criteria corresponding to respective ones of the plurality of folders.

2. The method of claim 1, further comprising:
associating a first time period with the query criteria; and
creating respective first worksheets in respective ones of the plurality of workbooks that contain the results from querying the employee database for respective ones of the query criteria for the first time period.

3. The method of claim 2, further comprising:
associating a second time period with the query criteria; and
creating respective second worksheets in respective ones of the plurality of workbooks that contain the results from querying the employee database for respective ones of the query criteria for the second time period.

4. The method of claim 1, further comprising:
automatically performing querying the employee database and creating the plurality of workbooks at a scheduled time.

5. The method of claim 1, further comprising:
receiving user input selecting one of the plurality of query criteria;
querying the employee database by applying the selected query criterion to respective ones of the plurality of employees; and
storing results from querying the employee database by applying the selected query criterion in respective ones of the plurality of workbooks for respective ones of the plurality of employees.

6. The method of claim 1, further comprising:
creating a log file containing a plurality of status indicators for respective ones of the plurality of query criteria.

7. The method of claim 6, wherein the plurality of status indicators comprise:
a query start time;
a query stop time; and
a number of employees for which the query is applicable.

8. The method of claim 1, wherein the plurality of query criteria comprises a plurality of employee performance criteria.

9. A system for querying an employee database, comprising:
means for defining a plurality of query criteria;
means for querying the employee database by applying respective ones of the query criteria to respective ones of a plurality of employees;
means for providing a plurality of folders, respective ones of the plurality of folders corresponding to respective ones of the plurality of query criteria; and
means for creating a plurality of workbooks containing results from querying the employee database for respective ones the plurality of folders, respective ones of the plurality of workbooks being associated with respective ones of the plurality of employees that have results for respective ones of the plurality of query criteria corresponding to respective ones of the plurality of folders.

10. The system of claim 9, further comprising:
means for associating a first time period with the query criteria; and
means for creating respective first worksheets in respective ones of the plurality of workbooks that contain the results from querying the employee database for respective ones of the query criteria for the first time period.

11. The system of claim 10, further comprising:
means for associating a second time period with the query criteria; and
means for creating respective second worksheets in respective ones of the plurality of workbooks that contain the results from querying the employee database for respective ones of the query criteria for the second time period.

12. The system of claim 9, further comprising:
means for automatically performing querying the employee database and creating the plurality of workbooks at a scheduled time.

13. The system of claim 9, further comprising:
means for receiving user input selecting one of the plurality of query criteria;
means for querying the employee database by applying the selected query criterion to respective ones of the plurality of employees; and
means for storing results from querying the employee database by applying the selected query criterion in respective ones of the plurality of workbooks for respective ones of the plurality of employees.

14. The system of claim 9, further comprising:
means for creating a log file containing a plurality of status indicators for respective ones of the plurality of query criteria.

15. The system of claim 14, wherein the plurality of status indicators comprise:
a query start time;
a query stop time; and
a number of employees for which the query is applicable.

16. The system of claim 9, wherein the plurality of query criteria comprises a plurality of employee performance criteria.

17. A computer program product for querying an employee database, comprising:
a computer readable storage medium having computer readable program code embodied therein, the computer readable program code comprising:
computer readable program code configured to define a plurality of query criteria;
computer readable program code configured to query the employee database by applying respective ones of the query criteria to respective ones of a plurality of employees;
computer readable program code configured to provide a plurality of folders, respective ones of the plurality of folders corresponding to respective ones of the plurality of query criteria; and
computer readable program code configured to create a plurality of workbooks containing results from querying the employee database for respective ones the plurality of folders, respective ones of the plurality of workbooks being associated with respective ones of the plurality of employees that have results for respective ones of the plurality of query criteria corresponding to respective ones of the plurality of folders.

18. The computer program product of claim 17, further comprising:
computer readable program code configured to associate a first time period with the query criteria; and
computer readable program code configured to create respective first worksheets in respective ones of the plurality of workbooks that contain the results from querying the employee database for respective ones of the query criteria for the first time period.

19. The computer program product of claim 18, further comprising:
computer readable program code configured to associate a second time period with the query criteria; and
computer readable program code configured to create respective second worksheets in respective ones of the plurality of workbooks that contain the results from querying the employee database for respective ones of the query criteria for the second time period.

20. The computer program product of claim 17, further comprising:
computer readable program code configured to automatically perform querying the employee database and creating the plurality of workbooks at a scheduled time.

21. The computer program product of claim 17, further comprising:
computer readable program code configured to receive user input selecting one of the plurality of query criteria;
computer readable program code configured to query the employee database by applying the selected query criterion to respective ones of the plurality of employees; and
computer readable program code configured to store results from querying the employee database by applying the selected query criterion in respective ones of the plurality of workbooks for respective ones of the plurality of employees.

22. The computer program product of claim 17, further comprising:
computer readable program code configured to create a log file containing a plurality of status indicators for respective ones of the plurality of query criteria.

23. The computer program product of claim 22, wherein the plurality of status indicators comprise:
a query start time;
a query stop time; and
a number of employees for which the query is applicable.

24. The computer program product of claim 17, wherein the plurality of query criteria comprises a plurality of employee performance criteria.
